(19) United States
(12) Patent Application Publication
(10) Pub. No.: US 2024/0124054 A1
(43) Pub. Date: Apr. 18, 2024

(54) Valve Device for a Steering Device of a Vehicle, Steering Device and Method and Control Device for Controlling a Valve Device

(71) Applicant: KNORR-BREMSE Systeme fuer Nutzfahrzeuge GmbH, Muenchen (DE)

(72) Inventor: Bernhard MILLER, Weil der Stadt (DE)

(21) Appl. No.: 18/277,605

(22) PCT Filed: Jan. 26, 2022
(86) PCT No.: PCT/EP2022/051739

§ 371 Date: Aug. 17, 2023

(30) Foreign Application Priority Data
Feb. 18, 2021 (DE) 10 2021 103 817.0

(51) Int. Cl. B62D 5/065; B62D 5/09; B62D 5/30

(52) U.S. Cl. CPC B62D 5/065; B62D 5/091; B62D 5/30; B62D 5/064

(57) ABSTRACT

A valve device for a steering device of a vehicle includes a pump device with a pump for pumping a working medium to a first discharge connection or a second discharge connection of the pump device and a motor for driving the pump. The valve device further has a valve and/or a storage container, wherein the valve and/or the storage container are switched between the first discharge connection of the pump device and the second discharge connection of the pump device.

### BACKGROUND AND SUMMARY

The present disclosure relates to a valve device for a steering apparatus of a vehicle, to a steering apparatus, and to a method and a control unit for controlling a valve device.

In steering systems of vehicles, in particular in front-axle steering systems, also referred to as power-assisted steering systems, of medium and heavy utility vehicles, a recirculating ball steering mechanism can be operated for example by means of an external, unidirectional hydraulic pump. A connection between pump and steering mechanism may be implemented for example by means of external pipework. It is thus possible to provide a distributed arrangement of individual components of such a steering system in the vehicle.

Against this background, it is the object of the present approach to create an improved valve device for a steering apparatus of a vehicle, an improved steering apparatus, an improved method for controlling a valve device, and an improved apparatus.

This object is achieved by a valve device, by a method, by a control unit, by a computer product, and by a steering apparatus, in accordance with the independent claims.

The advantages that can be achieved with the proposed approach consist in that, for example, a rapid pressure drop or a uniform thermal load on coils is made possible.

Against this background, a valve device for a steering apparatus of a vehicle is proposed, which valve device has a pump device and a valve and/or a reservoir. The pump device in turn has a pump for pumping a working medium to a first output connection or a second output connection of the pump device, and a motor for driving the pump. The valve and additionally or alternatively the reservoir are connected between the first output connection of the pump device and the second output connection of the pump device.

The steering apparatus is usable for example in a vehicle, for example a utility vehicle. This means that the valve device, which can be part of the steering apparatus, can be used in the vehicle. The steering apparatus may in this case be configured to assist steering movements input by a driver of the vehicle, because the vehicle may for example have a weight of several tonnes. The pump device may for example be configured to pump the working medium through the steering apparatus. The motor may for example be implemented as a motor, and the pump may for example be implemented as a bidirectional hydraulic pump. The reservoir can for example also be referred to as an expansion tank. The working medium may for example be a fluid, such as a hydraulic oil.

In one embodiment, the valve device may have at least one check valve that is connected between the first output connection of the pump device and the valve and additionally or alternatively the reservoir. Additionally or alternatively, the check valve and additionally or alternatively a further check valve may be connected between the second output connection of the pump device and the valve and additionally or alternatively the reservoir. The check valve and additionally or alternatively the further check valve are advantageously configured to define or specify a flow direction of the working medium.

In one embodiment, the check valve may be configured to allow the working medium to pass through in the direction of the first output connection, and additionally or alternatively the further check valve may be configured to allow the working medium to pass through in the direction of the second output connection. A flow direction of the working medium can advantageously thus be defined or specified.

In one embodiment, the valve device may have an additional check valve that is arranged between the first output connection and a first valve connection of the valve. Here, the additional check valve may be configured to allow the working medium to pass through in the direction of the first valve connection. In this case, too, flow direction of the working medium can advantageously thus be defined or specified.

In one embodiment, the valve device may have another check valve that is arranged between the second output connection and the first valve connection. Here, the other check valve may be configured to allow the working medium to pass through in the direction of the first valve connection. A further advantageous flow direction of the fluid can thus be defined or specified.

In one embodiment, the valve may be directly connected to the reservoir. This means that the valve is fluidically connected to the reservoir. The working medium, and additionally or alternatively portions thereof, can advantageously thus be discharged into the reservoir by means of the valve.

In one embodiment, the valve may be formed as a proportional valve. The proportional valve may be a continuous valve which, by means of a proportional magnet, allows a continuous transition of a degree of valve opening. It is advantageously thus possible, for example, to realize variable volume flows through the valve.

In one embodiment, the valve may be configured to be fully opened if a fault and additionally or alternatively an electrical failure is detected in at least a part of the vehicle. The fault may for example be a malfunction. The opening of the valve can advantageously be used as a safety function.

Also proposed as a method for controlling a valve device in one of the above-stated variants, wherein the method comprises an outputting step. In the outputting step, a valve opening signal, which represents an at least partial opening of the valve device, and additionally or alternatively a valve closing signal, which represents an at least partial closure of the valve device, is output.

The method may be provided for example for the valve device of a steering apparatus. Here, a degree of opening of the valve may advantageously be determined. The method may be carried out for example by the control unit of the steering apparatus.

Said method may be implemented for example in software or hardware, or in a mixture of software and hardware, for example in the control unit.

A control unit proposed here according to one embodiment is for example configured to provide a valve opening signal for opening the valve device of the steering apparatus to the valve device and additionally or alternatively a valve closing signal for closing the valve device to the valve device, and to carry out the step of the method in a corresponding unit.

The approach proposed here therefore creates the control unit that is configured to carry out, control and/or implement the step of a variant of the method proposed here in corresponding devices. By means of this design variant of the approach in the form of a control unit, too, the object on which the approach is based can be achieved quickly and efficiently.

For this purpose, the control unit may have at least one processing unit for processing signals or data, at least one memory unit for storing signals or data, at least one interface to a sensor or an actuator for the purposes of reading in sensor signals from the sensor or for the purposes of outputting data or control signals to the actuator, and/or at least one communication interface for reading in or outputting data that are embedded in a communication protocol. The processing unit may for example be a signal processor, a microcontroller or the like, wherein the memory unit may be a flash memory, an EPROM or a magnetic memory unit. The communication interface may be configured to read in or output data wirelessly and/or by wire, wherein a communication interface that can read in or output data by wire may for example electrically or optically read in said data from a corresponding data transmission line or output said data into a corresponding data transmission line.

A control unit may in this case be understood to mean an electrical appliance which processes sensor signals and, based on these, outputs control and/or data signals. The control unit may have an interface that may be implemented in hardware and/or software form. If in hardware form, the interfaces may for example be part of a so-called system ASIC, which encompasses a wide variety of functions of the control unit. The interfaces may however also be dedicated integrated circuits or be at least partially composed of discrete components. If in software form, the interfaces may be software modules that are present for example on a microcontroller in addition to other software modules.

In one advantageous embodiment, the control unit is used to control a method for controlling a valve device. For this purpose, the control unit may for example access sensor signals such as a valve opening signal for opening the valve device and/or a valve closing signal for closing the valve device. The control is performed using actuators such as a providing unit that is configured to provide the valve opening signal and/or the valve closing signals.

Also proposed is a steering apparatus for a vehicle, which steering apparatus has a valve device in one of the variants proposed above, a mechanism device, and a control unit. Here, the mechanism device has an input shaft, which is couplable to a steering wheel, and having an output shaft, which is couplable to a steering gear arm, and furthermore a mechanism element, which is movable in a first direction and a second direction for the purposes of transmitting a torque from the input shaft to the output shaft, and a first working medium connection and a second working medium connection. Here, the first working medium connection is connected to the first output connection of the valve device for the purposes of moving the mechanism element in the first direction using the working medium, and the second working medium connection is connected to the second output connection of the valve device for the purposes of moving the mechanism element in the second direction using the working medium.

The steering apparatus may be implemented for example in a utility vehicle in order to assist a steering movement. The mechanism device can for example also be referred to as a steering gear.

In one embodiment, the motor may be configured not to move the steering lever when the valve device is open. The steering apparatus is advantageously thus kept for example in an idle state whilst a vehicle engine is running.

Exemplary embodiments of the approach proposed here will be discussed in more detail in the following description with reference to the figures.

### BRIEF DESCRIPTION OF THE DRAWINGS

FIG. 1 is a schematic block diagram of a vehicle having a steering apparatus according to an exemplary embodiment;

FIG. 2 is a schematic illustration of a steering apparatus according to an exemplary embodiment; and

FIG. 3 is a flow diagram of a method for controlling a valve device according to an exemplary embodiment.

In the following description of expedient exemplary embodiments of the present approach, the same or similar reference designations will be used for elements of similar action illustrated in the various figures, wherein a description of these elements will not be repeated.

### DETAILED DESCRIPTION OF THE DRAWINGS

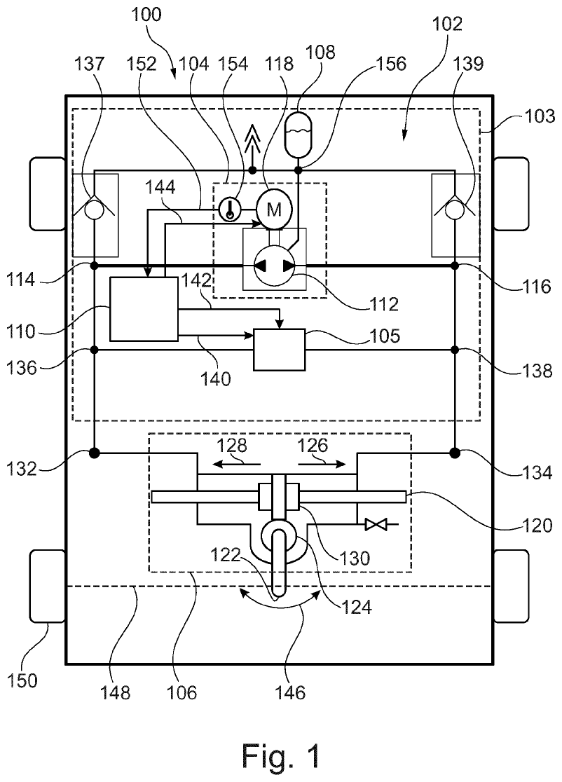

FIG. 1 shows a schematic block diagram of a vehicle 100 having a steering apparatus 102 according to an exemplary embodiment. The vehicle 100 may be implemented for example as a utility vehicle that is configured primarily to transport objects. Since the vehicle 100 may have a weight of several tonnes, the vehicle 100 has the steering apparatus 102. The steering apparatus 102 is configured to assist a steering action by an occupant of the vehicle 100, for example a driver of the vehicle 100. For this purpose, the steering apparatus 102 has a valve device 103 having a pump device 104 and having a valve 105 and/or having a reservoir 108, and has a mechanism device 106 and a control unit 110. Here, the pump device 104 comprises a pump 112 for pumping a working medium to a first output connection 114 or a second output connection 116, a motor 118, for example an electric motor, that is configured to drive the pump 112, and a housing, through which the first output connection 114 and the second output connection 116 are led and which is arranged around the pump 112 and the motor 118. In this exemplary embodiment, the pump 112 is arranged on a common shaft with the motor 118. In this exemplary embodiment, the motor 118 may be implemented as a disk-rotor motor. The pump 112 may be implemented for example as a bidirectional hydraulic pump.

The mechanism device 106 has an input shaft 120, which is couplable to a steering wheel, and an output shaft 124, which is couplable to a steering lever 122. The mechanism device 106 furthermore has a mechanism element 130, which is movable in a first direction 126 and a second direction 128 for the purposes of transmitting a torque from the input shaft 120 to the output shaft 124. The mechanism device 106 furthermore comprises a first working medium connection 132 and a second working medium connection 134, wherein the first working medium connection 132 is connected to the first output connection 114 for the purposes of moving the mechanism element 130 in the first direction 126 using the working medium, and the second working medium connection 134 is connected to the second output connection 116 for the purposes of moving the mechanism element 130 in the second direction 128 using the working medium. In this exemplary embodiment, the input shaft 120 is for example configured to introduce a torque from a steering column (not illustrated here) of the vehicle 100, to which the input shaft 120 is connectable or connected, into the steering apparatus 102. The torque introduced via the input shaft 120 can also be referred to as an input torque. In this exemplary embodiment, the input shaft 120 is connected or mechanically coupled via the steering column of the steering system to a steering wheel (not illustrated here) of the vehicle 100. In this exemplary embodiment, the output shaft 124 is configured to transfer the torque out of the steering apparatus 102, or to output the torque to the steering lever 122. The torque transferred out via the output shaft 124 can also be referred to as an output torque or an output force. In this exemplary embodiment, the mechanism element 130 is configured to mechanically transmit the torque from the input shaft 120 to the output shaft 124 and/or to convert the input torque into the output torque.

In this exemplary embodiment, the valve 105 and/or the reservoir 108 are connected between the first output connection 114 and the second output connection 116 of the pump device 104. This accordingly means that, in this exemplary embodiment, the valve 105 has a first valve connection 136 and a second valve connection 138. In this exemplary embodiment, the valve 105 is implemented as a proportional valve. In this exemplary embodiment, the first valve connection 136 is arranged between the first output connection 114 and the first working medium connection 132. Analogously, in this exemplary embodiment, the second valve connection 138 is arranged between the second output connection 116 and the second working medium connection 134. In an alternative exemplary embodiment, the arrangement of the valve 105 is however variable, as will be discussed in more detail in one of the following figures. In this exemplary embodiment, the valve 105 is configured to be fully opened if a fault and/or an electrical failure is detected in at least a part of the vehicle 100. In this exemplary embodiment, the valve device 103 has at least one check valve 137 that is connected between the first output connection 114 and the valve 105 and/or the reservoir 108. The check valve 137 and/or a further check valve 139 are connected between the second output connection 116 of the pump device 104 and the valve 105 and/or the reservoir 108. In this exemplary embodiment, the check valve 137 is configured to allow the working medium to pass through in the direction of the first output connection 114. The further check valve 139 is configured to allow the working medium to pass through in the direction of the second output connection 116.

The steering apparatus 102 furthermore has the control unit 110, which is configured to provide a valve opening signal 140 for opening the valve 105 of the steering apparatus 102 to the valve 105 and/or to provide a valve closing signal 142 for closing the valve 105 to the valve 105. The control unit 110 is optionally configured to provide a motor signal 144 to the motor 118 in order to operate the motor 118 of the steering apparatus 102. This means that the motor 118 does not move the steering lever 122 when the valve 105 is open. Conversely, this means that the valve 105 blocks a flow of the working medium through the valve 105 when the valve 105 is closed, such that, in this exemplary embodiment, said working medium is pumped through the mechanism device 106 and transmits a steering direction 146, which is input by the driver of the vehicle 100, via a steering rod 148 to vehicle wheels 150.

Optionally, in this exemplary embodiment, the control unit 110 controls the motor 118 in response to temperature signal 152 that indicates a temperature. In one exemplary embodiment, the temperature signal 152 is provided by a temperature sensor 154, for example a thermometer, to the control unit 110. In this exemplary embodiment, the temperature sensor 154 is implemented or implementable as part of the pump device 104. Alternatively, the temperature sensor 154 may also be arranged in some other way in the vehicle 100. The pump device 104 optionally also has an input connection 156 via which the pump device 104 is, in this exemplary embodiment, connected to the reservoir 108 for storing the working medium.

In other words, a valve device 103 having a multifunctional valve 105, which is also referred to as a backup valve, is proposed. In this exemplary embodiment, the valve device 103 is provided for use for a steering system in the form of the steering apparatus 102 of the vehicle 100, for example a heavy goods vehicle. In this exemplary embodiment, the steering apparatus 102 is controlled by means of a bidirectionally operating pump 112, for example a hydraulic pump.

Here, the pump 112 is connected to the mechanism device 106. In this exemplary embodiment, in an emergency situation, the valve device 103 connects two cylinder chambers of a double-acting cylinder that is arranged in the mechanism device 106, thus enabling the vehicle 100 to be steered for example in the event of malfunction or in the event of a failure of a hydraulic assistance system. During normal driving operation, various functional improvements are made possible by brief or small opening operations. The approach proposed here therefore allows emergency functioning of safety-relevant systems in the event of a system failure, for example.

To be able to implement any desired switching cross section, the valve 105 is formed as a proportional valve which, when electrically deenergized, opens up a full passage for the working medium. If a fault is detected, or in the event of an electrical failure, the valve 105 is fully opened. To improve a dynamic operating behavior of the steering apparatus 102, this fast-opening valve 105 allows a faster pressure drop in the relevant cylinder chamber. In the case of a high constant pressure being maintained for a relatively long time in one of the two cylinder chambers, the valve 105 is for example opened slightly by means of the valve opening signal 140, such that the motor 118 slowly rotates and thus all of the coils of the motor 118 are subjected to uniform thermal load.

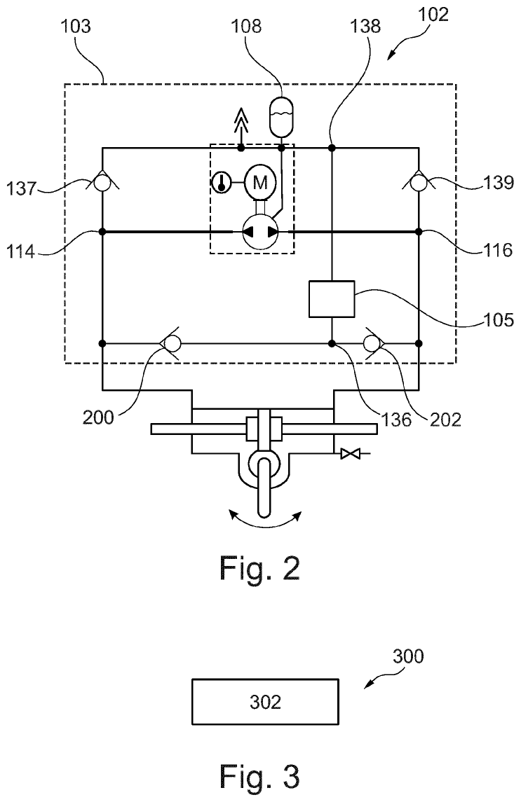

FIG. 2 is a schematic illustration of a steering apparatus 102 according to an exemplary embodiment. The steering apparatus 102 illustrated here may correspond to the steering apparatus 102 described in FIG. 1, and is thus usable in a vehicle as described in FIG. 1. In this exemplary embodiment, the valve device 103 has not only the check valve 137 and the further check valve 139 but also an additional check valve 200, which is arranged between the first output connection 114 and the first valve connection 136 of the valve 105, wherein the additional check valve 200 is configured to allow the working medium to pass through in the direction of the first valve connection 136. Furthermore, in this exemplary embodiment, the valve device 103 also has another check valve 202, which is arranged between the second output connection 116 and the first valve connection 136. Here, the other check valve 202 is configured to allow the working medium to pass through in the direction of the first valve connection 136. In this exemplary embodiment, the valve 105 is directly connected to the reservoir 108, for example by means of the second valve connection 138. It is thus possible, for example, for the working medium, when it expands, to pass into the reservoir 108.

In other words, in this exemplary embodiment, the valve 105 is arranged such that the working medium can be discharged from each one of the two cylinders of the mechanism device into the reservoir 108. This means that, in the event of a rapid dissipation of pressure as a result of the valve 105 being opened, the volume of the working medium, which increases owing to compressibility, is discharged into the reservoir 108. It is thus for example possible to avoid a residual pressure in a cylinder chamber. In the event of only a small steering deflection, for example whilst the vehicle is in motion, the valve 105 is optionally opened only slightly in order to achieve a higher pump rotational speed. This allows an oil film to form, resulting in lower friction in the pump.

FIG. 3 shows a flow diagram of a method 300 for controlling a valve device according to an exemplary embodiment. The method 300 can be carried out for example in a steering apparatus as has been described in either of FIGS. 1 and 2. Here, the method 300 comprises a step 302 of outputting a valve opening signal, which represents an at least partial opening of the valve device, and/or a valve closing signal, which represents an at least partial closure of the valve device.

Where an exemplary embodiment includes an “and/or” combination between a first feature and a second feature, this is to be read as meaning that the exemplary embodiment, in one embodiment, has both the first feature and the second feature, and in a further embodiment, has either only the first feature or only the second feature.

### LIST OF REFERENCE DESIGNATIONS

100 Vehicle
102 Steering apparatus
103 Valve device
104 Pump device
105 Valve
106 Mechanism device
108 Reservoir
110 Control unit
112 Pump
114 First output connection
116 Second output connection
118 Motor
120 Input shaft
122 Steering lever
124 Output shaft
126 First direction
128 Second direction
130 Mechanism element
132 First working medium connection
134 Second working medium connection
136 First valve connection
137 Check valve
138 Second valve connection
139 Further check valve
140 Valve opening signal
142 Valve closing signal
144 Motor signal
146 Steering direction
148 Steering rod
150 Vehicle wheels
152 Temperature signal
154 Temperature sensor
156 Input connection
200 Additional check valve
202 Other check valve
300 Method for controlling a valve device
302 Outputting step

1.-14. (canceled)

15. A valve device for a steering apparatus of a vehicle, comprising:
a pump device having a pump for pumping a working medium to a first output connection or a second output connection of the pump device, and having a motor for driving the pump; and
a valve and/or a reservoir, wherein
the valve and/or the reservoir is connected between the first output connection of the pump device and the second output connection of the pump device.

16. The valve device as claimed in claim 15, further comprising:
a first check valve, wherein
the first check valve is connected between the first output connection of the pump device and the valve and/or the reservoir, and/or
the first check valve and/or a second check valve is connected between the second output connection of the pump device and the valve and/or the reservoir.

17. The valve device as claimed in claim 16, wherein
the first check valve is configured to allow the working medium to pass through in the direction of the first output connection, and/or
the second check valve is configured to allow the working medium to pass through in the direction of the second output connection.

18. The valve device as claimed in claim 16, further comprising:
a third check valve which is arranged between the first output connection and a first valve connection of the valve, wherein
the third check valve is configured to allow the working medium to pass through in the direction of the first valve connection.

19. The valve device as claimed in claim 18, further comprising:
a fourth check valve which is arranged between the second output connection and the first valve connection, wherein the fourth check valve is configured to allow the working medium to pass through in the direction of the first valve connection.

20. The valve device as claimed in claim 15, wherein the valve is directly connected to the reservoir.

21. The valve device as claimed in claim 15, wherein the valve is a proportional valve.

22. The valve device as claimed in claim 15, wherein
the valve is configured to be fully opened when a fault and/or an electrical failure is detected in at least a part of the vehicle.

23. A method for controlling a valve device for a steering apparatus of a vehicle having a pump for pumping a working medium to a first output connection or a second output connection and having a motor for driving the pump, wherein the valve is connected between the first output connection and the second output connection,
the method comprising:
outputting a valve opening signal, which represents an at least partial opening of the valve device, and/or
outputting a valve closing signal, which represents an at least partial closure of the valve device.

24. A steering apparatus for a vehicle, comprising:
a valve device for the steering apparatus, the valve device comprising a pump for pumping a working medium to a first output connection or a second output connection, a motor for driving the pump, and a valve and/or a reservoir, wherein the valve and/or the reservoir is connected between the first output connection and the second output connection;
a first mechanism having an input shaft, which is couplable to a steering wheel, and having an output shaft, which is couplable to a steering lever,
a torque transmitting element, which is movable in a first direction and a second direction for transmitting a torque from the input shaft to the output shaft, and having a first working medium connection and a second working medium connection, wherein
the first working medium connection is connected to the first output connection for moving the torque transmitting element in the first direction using the working medium, and the second working medium connection is connected to the second output connection for moving the torque transmitting element in the second direction using the working medium; and
a control unit configured to:
provide a valve opening signal to the valve device for opening the valve device of the steering apparatus, and/or
provide a valve closing signal to the valve device for closing the valve device.

25. The steering apparatus as claimed in claim 24, wherein
the motor is configured not to move the steering lever when the valve device is open.
